(19) United States
(12) Patent Application Publication
(10) Pub. No.: US 2004/0248692 A1
(43) Pub. Date: Dec. 9, 2004

(54) Enclosed axle differential lock mechanism

(75) Inventors: Thomas Steven Bryson, Chambersburg, PA (US); Mark Allan Winders, Hagerstown, MD (US); Richard Duane Schnurr, Williamsport, MD (US)

Correspondence Address: ROTHWELL, FIGG, ERNST & MANBECK, P.C., 1425 K STREET, N.W., SUITE 800, WASHINGTON, DC, 20005, US

(73) Assignee: Mack Trucks, Inc., Allentown, PA (US)

(21) Appl. No.: 10/809,921

(22) Filed: Mar. 26, 2004

Related U.S. Application Data
(63) Continuation of application No. 10/162,199, filed on Jun. 5, 2002.
(60) Provisional application No. 60/298,906, filed on Jun. 19, 2001.

(51) Int. Cl. F16H 48/06

(52) U.S. Cl. 475/231

(57) ABSTRACT

An enclosed axle differential lock is provided which includes an axle carrier assembly within which is a bearing having a bearing cap. A differential housing rotates, supported by the bearing, with a pinion gear and a side gear each rotating in the differential housing and meshing together. An axle is driven by the side gear. A clutch may be used to lock the differential housing and the axle together. The clutch includes a first clutch element fixed to the differential housing and a second clutch element splined on the axle and axially movable thereon, the second clutch element having a first disengaged position in which the first clutch element and the second clutch element are substantially disconnected, and a second engaged position in which the first clutch element and the second clutch element are substantially drivingly connected. An actuator is integrally disposed in the bearing cap which urges the second clutch element from the first disengaged position to the second engaged position. The actuator may be pneumatic, hydraulic, or electronic.

### CROSS-REFERENCE TO RELATED APPLICATIONS

This application is a continuation of U.S. application Ser. No. 10/162,199, filed Jun. 5, 2002, which claims the benefit of Provisional Application Ser. No. 60/298,906, filed Jun. 19, 2001, the disclosure of which is incorporated by reference.

### BACKGROUND OF THE INVENTION

1. Field of the Invention

The present invention relates to differentials, and more particularly, to locking differentials.

2. Description of the Related Art

When a wheeled vehicle turns in a circle, the outer wheels traverse a longer distance than the inner wheels. The outer wheels must consequently rotate at a higher velocity than the inner wheels in order to cover the longer distance during the time the vehicle is turning. A differential allows a pair of axle shafts that are being driven by a single input shaft to rotate at different velocities. Wheels attached to the axle shafts may thus rotate at different velocities. A differential will thus allow a vehicle to turn in a circle without, e.g. ‘scrubbing’ its tires.

Differentials are generally comprised of a differential housing rotating within an axle carrier assembly about an axis of rotation of a pair of axle shafts. The differential housing has at least two pinion gears arranged about its circumference. The pinion gears mesh in turn with side gears attached to the axle shafts. A ring gear connected to the differential housing turns the differential housing about the axis of rotation. The ring gear is in turn driven by another pinion gear at the end of an input shaft.

As long as each of the wheels attached to the axle shafts have some traction, the differential housing turns the side gears substantially as a unit while accommodating minor differences in rotational velocity between them. If, however, one wheel happens to have a lower coefficient of friction, if e.g. it happens to be on a slippery surface, such as ice or loose gravel, a very small amount of torque applied to that wheel may cause it to spin. Under such conditions, the wheel experiencing the lower coefficient of friction loses traction and “spins out”.

Furthermore, even if the other wheel has traction, it will not be able to apply much tractive effort, since the torque applied to the wheel with the least traction limits the torque to the other wheel. Thus the wheel that has traction may not receive enough torque to turn.

Various methods of compensating for lost traction have been proposed. One method is to temporarily lock one of the side gears or one of the axles to the differential housing. This causes both axles to turn as a unit with the differential housing, since the pinion gears transfer torque from the locked axle to the other axle. The axle thus approximates a solid or ‘spool’ axle while the lock is engaged. The lock may be disengaged when a less slippery surface is reached, returning the differential housing to its differential function.

The lock may be a friction clutch or a dog clutch situated between the side gear or the axle and the differential housing. When traction is lost, the clutch may be engaged until traction is regained. Such locks may be engaged in various ways. One way is by pushing a lever with a fork around a collar attached to an axially movable plate or side of the clutch. The fork urges the axially movable side of the clutch toward the other side. The lever may be pushed by, e.g. pedal pressure supplied by the driver through a cable, or by pneumatic, electronic, or hydraulic pressure.

The lever and associated activation hardware are often attached to the axle carrier assembly. If such a locking differential is an option selected by only a portion of a vehicle's customers, the entire axle carrier assembly may have to be designed to accommodate both locking and open differentials. It would be desirable for the mechanism for locking a locking differential to be integral to a bearing cap of the axle carrier assembly, so that only the bearing cap would need to be designed to accommodate a locking differential.

It would also be desirable for the mechanism for locking a locking differential to be integral to a bearing cap of the axle carrier assembly, so that the mechanism could be assembled to the bearing cap at a location remote from a assembly line. The mechanism could then be delivered to an assembly line for assembly on selected vehicles as a unit. This may, for example, reduce improper installation of the differential lock if, for example, the differential lock is such an infrequent accessory that the assemblers are less familiar with its installation. It may also reduce the total cost of assembling the vehicle if a cheaper assembly point can be found for the lock mechanism.

Furthermore, if the lever and associated activation hardware are attached to the axle carrier assembly, it will be difficult to retrofit a differential lock to an existing vehicle without modifying the axle carrier assembly substantially, or replacing it. It would be desirable for the mechanism for locking a locking differential to be integral to a bearing cap of the axle carrier assembly, so that only that bearing cap would need to be modified or replaced to retrofit a differential lock to an existing vehicle.

Furthermore, if the lever and associated activation hardware are attached to the axle carrier assembly, inspection and adjustment of the lever and associated hardware may be required, necessitating access windows to be placed in the axle carrier assembly. Such windows may form leak paths for oil contained in the axle carrier assembly. It would be desirable for the mechanism for locking a locking differential to be contained completely within a axle carrier assembly.

### SUMMARY

In one embodiment, an enclosed axle differential lock apparatus includes an axle carrier assembly in which a bearing having a bearing cap is fixedly disposed within the axle carrier assembly, a differential housing rotatably supported by the bearing, a pinion gear rotatably supported in the differential housing, a side gear rotatably supported in the differential housing, the side gear meshingly engaged with the pinion gear, an axle drivingly connected to the side gear, a clutch disposed between the differential housing and the axle, the clutch comprising a first clutch element drivingly disposed on the differential housing and a second clutch element drivingly disposed on the axle and axially movable thereon, the second clutch element having a first disengaged position in which the first clutch element and the second clutch element are substantially disconnected, the second clutch element having a second engaged position in which the first clutch element and the second clutch element are substantially drivingly connected, and an actuator integrally disposed in the bearing cap, wherein the actuator urges the second clutch element from the first disengaged position to the second engaged position. The actuator may be pneumatic, hydraulic, or electronic.

In another embodiment, a vehicle includes a chassis, an axle tube elastically disposed on the chassis, an axle carrier assembly fixedly connected to the axle tube, a bearing having a bearing cap fixedly disposed within the axle carrier assembly, a differential housing rotatably supported by the bearing, a pinion gear rotatably supported in the differential housing, a side gear rotatably supported in the differential housing, the side gear meshingly engaged with the pinion gear, an axle drivingly connected to the side gear, the axle rotatably disposed within the axle tube, a clutch disposed between the differential housing and the axle, the clutch comprising a first clutch element drivingly disposed on the differential housing and a second clutch element drivingly disposed on the axle and axially movable thereon, the second clutch element having a first disengaged position in which the first clutch element and the second clutch element are substantially disconnected, the second clutch element having a second engaged position in which the first clutch element and the second clutch element are substantially drivingly connected, and an actuator integrally disposed in the bearing cap, wherein the actuator urges the second clutch element from the first disengaged position to the second engaged position. The actuator may be pneumatic, hydraulic, or electronic.

### BRIEF DESCRIPTION OF THE SEVERAL VIEWS OF THE DRAWINGS

FIG. 1 shows a differential lock mechanism according to a first embodiment of the invention;

FIG. 2 shows a vehicle upon which an embodiment of the differential lock mechanism may be installed;

FIG. 3 shows the embodiment of FIG. 1 in a disengaged position;

FIG. 4 shows the embodiment of FIG. 1 in an engaged position;

FIG. 5 shows a double acting cylinder for use with an embodiment of the invention;

FIG. 6 shows a lever for use with an embodiment of the invention;

FIG. 7 shows a differential lock mechanism according to a second embodiment of the invention;

FIG. 8 shows a differential lock mechanism according to a third embodiment of the invention;

FIG. 9 shows bearings for use with an embodiment of the invention; and

FIG. 10 shows clutches for use with an embodiment of the invention.

### DETAILED DESCRIPTION OF THE PREFERRED EMBODIMENTS

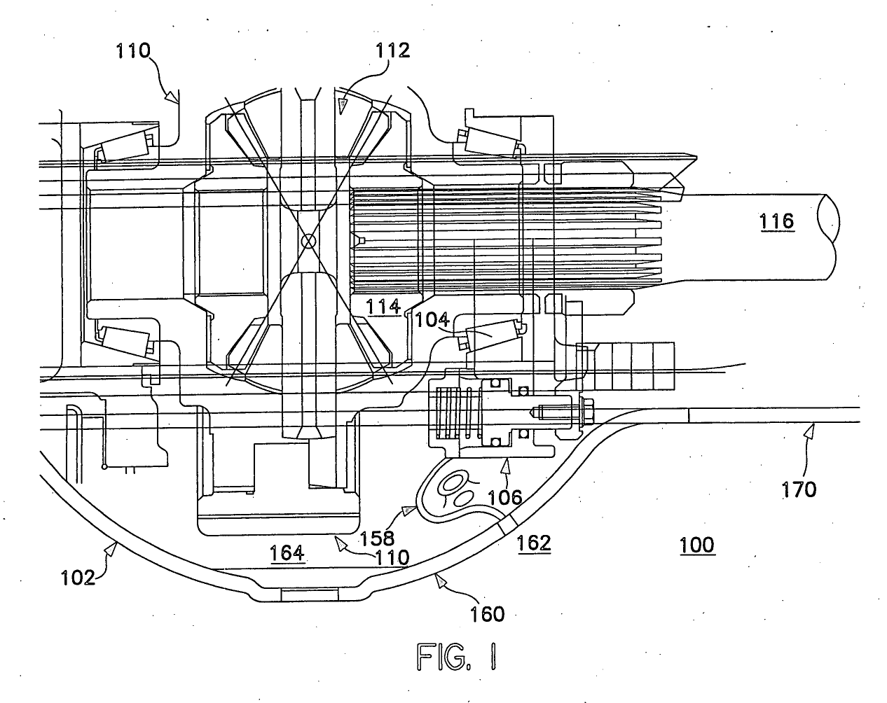

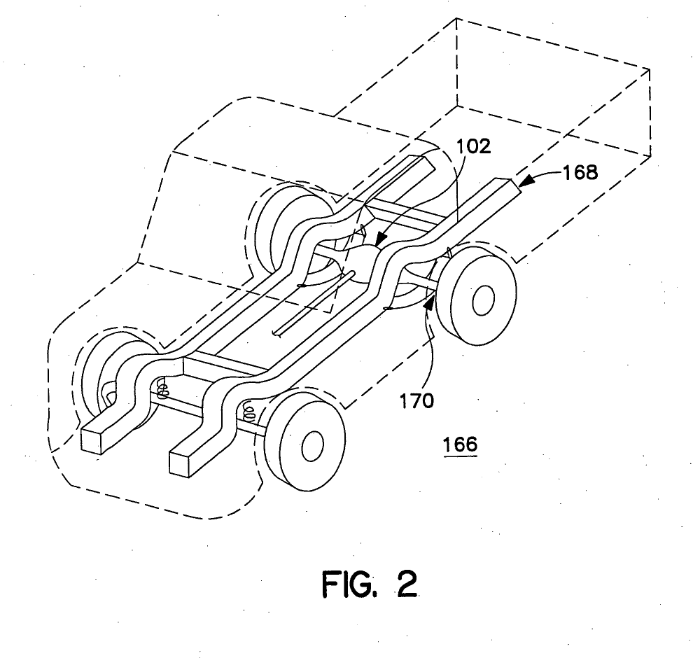

In FIG. 1 is shown an enclosed axle differential lock apparatus 100 according to a first embodiment of the invention. Apparatus 100 may be installed, e.g. in a vehicle 166 which has a chassis 168 upon which an axle tube 170 is elastically disposed, as shown in FIG. 2. Axle tube 170 may be elastically disposed on chassis 168 by means of, e.g. leaf springs, pneumatic springs, or coil springs, as would be known to those skilled in the art. An axle carrier assembly 102 may be fixedly connected to axle tube 170.

Apparatus 100 is contained within axle carrier assembly 102, which also has at least one bearing 104 having a bearing cap 106 fixedly disposed within axle carrier assembly 102. Bearing 104 supports rotatably a differential housing 110. Differential housing 110 may, e.g. be attached to a ring gear which meshes with a pinion gear on an input shaft, as would be known to those skilled in the art.

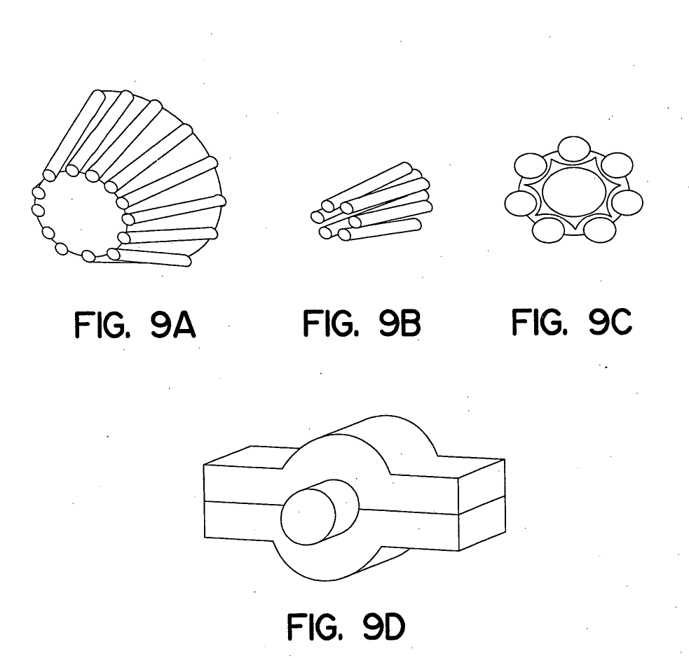

Bearing 104 may be, e.g. a rolling element bearing, such as a tapered roller bearing, a needle bearing, or a ball bearing, as shown in FIGS. 9A-9C. In this case bearing cap 106 may retain, e.g. a bearing race within bearing 104. A surface of differential housing 110 may provide, e.g. an inner surface of the bearing 104. Bearing 104 may also be, e.g., or a hydrodynamic or hydrostatic bearing, as shown in FIG. 9D, in which case bearing cap 106 provides an outer surface of bearing 104 upon which a lubricating film may accumulate.

A pinion gear 112 and a side gear 114 may both be rotatably supported by differential housing 110 so that pinion gear 112 is meshingly engaged with side gear 114. Side gear 114 is generally co-linear with an axis of rotation of differential housing 110, while pinion gear 112 revolves with differential housing 110 around the same axis of rotation, as would be known to those skilled in the art. An axle 116, which is rotatably disposed within axle tube 170, is drivingly connected to side gear 114. In this way an input torque imposed on the ring gear by the input shaft may be transferred through the pinion gear 112 to the side gear 114, and thence to axle 116, as would be known to those skilled in the art.

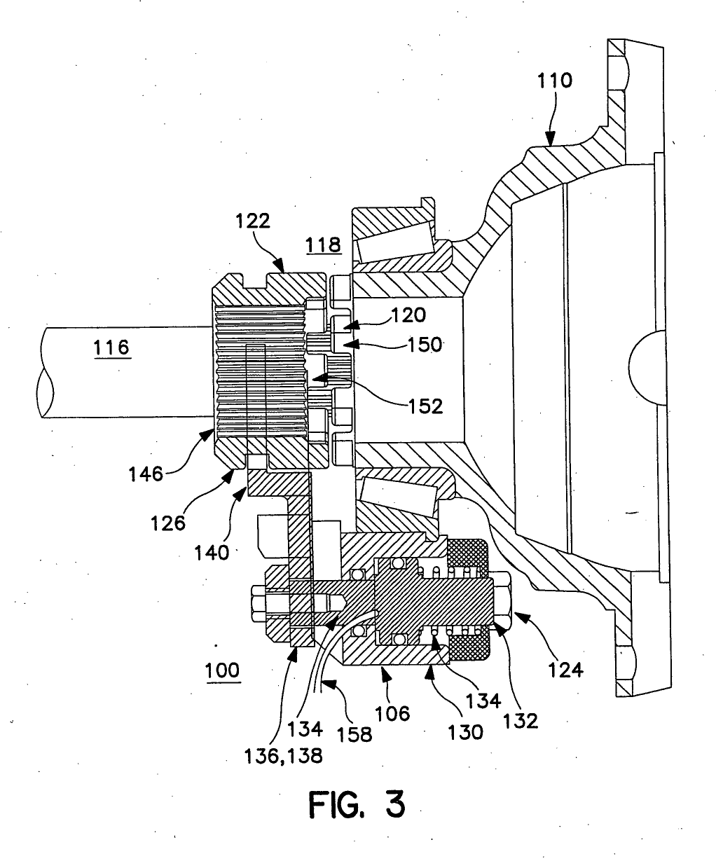

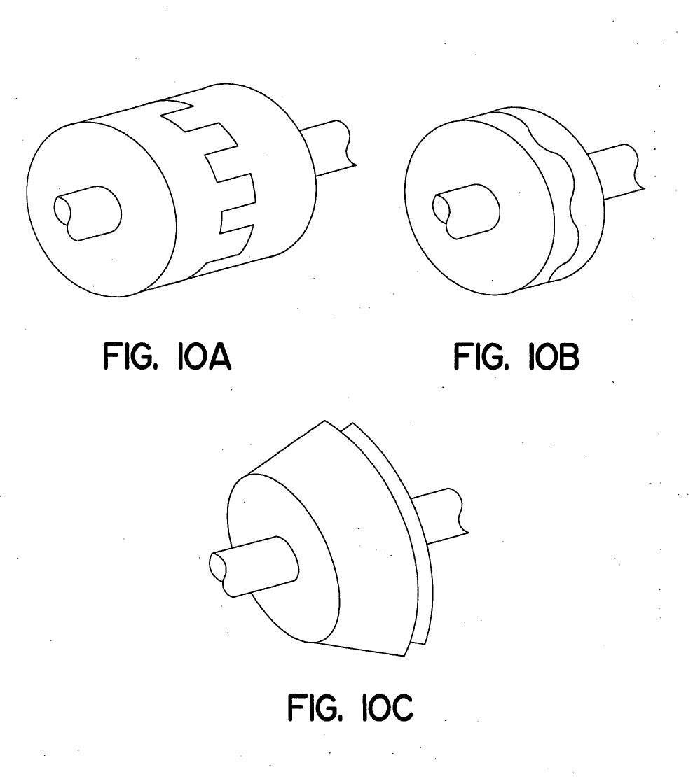

A clutch 118 may be disposed between differential housing 110 and axle 116, as shown in FIG. 3. Clutch 118 may be, e.g. a dog clutch, a viscous clutch, or a cone clutch, as shown in FIGS. 10A-10C. Clutch 118 may, e.g. include a first clutch element 120 drivingly disposed on differential housing 110, and a second clutch element 122 drivingly disposed on axle 116 and axially movable along axle 116.

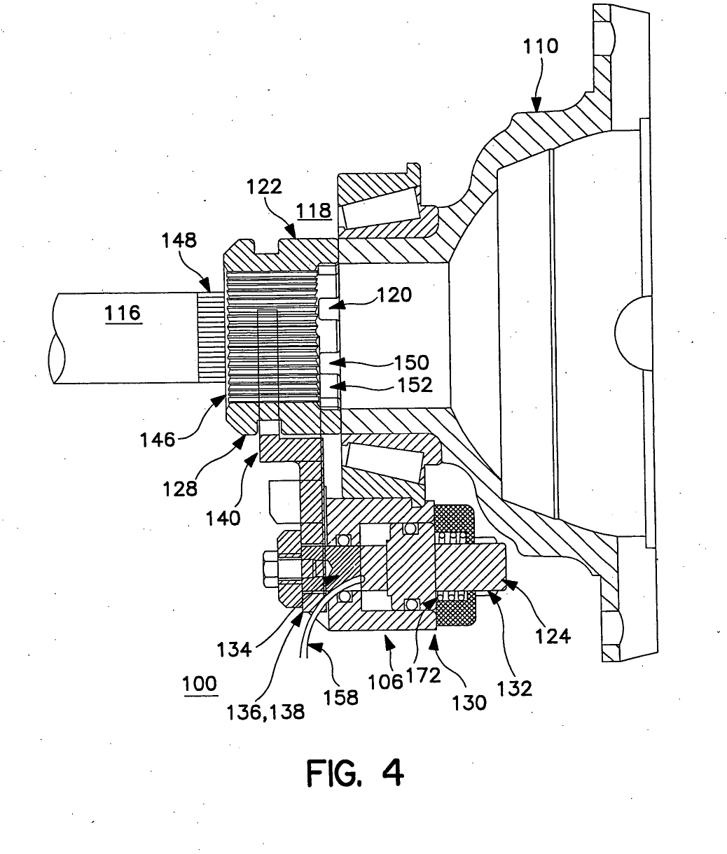

If first clutch element 120 were, e.g. a dog clutch, first clutch element 120 may have a plurality of first gear teeth 150 disposed angularly about an axis of rotation of axle 116. Second clutch element 122 may also have a plurality of second gear teeth 152 disposed angularly about the axis of rotation of axle 116, such that first gear teeth 150 are meshingly connected to second gear teeth 152 when second clutch element 122 is in a second engaged position 128, as shown in FIG. 4.

An actuator 124 integrally disposed in bearing cap 106 may move second clutch element 122 from a first disengaged position 126, as shown in FIG. 3, in which first clutch element 120 and second clutch element 122 are substantially disconnected, to a second engaged position 128, as shown in FIG. 4, in which first clutch element 120 and second clutch element 122 are substantially drivingly connected. Since actuator 124 is integrally disposed in bearing cap 106, which is, in turn, disposed within axle carrier assembly 102, a mechanism of actuator 124 is fully contained within axle carrier assembly 102.

Second clutch element 122 may have, e.g. a first spline element 146. First spline element 146 may be, e.g. an internal, straight spline, such as a set of substantially elongated ridges fixedly connected to second clutch element 122 parallel to an axis of rotation of second clutch element 122 such that a rotary motion of first spline element 146 will be transferred to second clutch element 122.

Axle 116 may have, e.g. a second spline element 148 fixedly connected to axle 116. First and second spline elements 146, 148 may, e.g. be complementary such that first spline element 146 is slidingly disposed on second spline element 148. Second spline element 148 may be, e.g. an external, straight spline, such as a set of substantially elongated ridges machined parallel to an axis of rotation of axle 116. In this case, a rotary motion of axle 116 will be transferred to second spline element 148, and thence to first spline element 146 and second clutch element 122. Since first spline element 146, and hence second clutch element 122, is slidingly disposed on second spline element 148, second clutch element 122 may move back and forth between first disengaged position 126 and second engaged position 128 by second clutch element 122 moving axially relative to second spline element 148.

In the first embodiment, actuator 124 may be, e.g. a pneumatic actuator. In this embodiment, actuator 124 may include a cylinder 130 fixedly disposed within bearing cap 106 containing a piston 132 slidingly disposed within cylinder 130. Piston 132 has a rod 134 to transfer pressure developed within cylinder 130 by a fluid introduced to cylinder 130 and acting on piston 132 to an external entity, such as a lever 136. In this embodiment, the fluid may be, e.g. air.

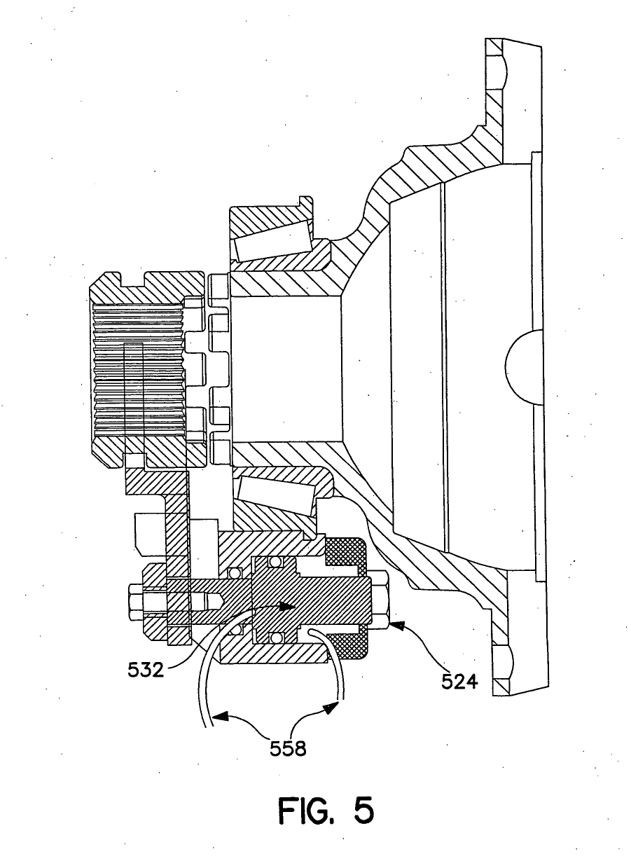

In one embodiment, as shown in FIG. 5, actuator 524 is a double-acting actuator. In this embodiment the fluid is supplied to either side of piston 532 through tubes 558, depending on which direction of travel is required. In a preferred embodiment, as shown in FIGS. 3, and 4, fluid is supplied to only one side of piston 132. In this embodiment a return spring 172 returns piston 132 to a starting position after the fluid is no longer being supplied to cylinder 130.

Actuator 124 may have, e.g. a tube 158 to supply the fluid to cylinder 130. Tube 158 may pass through a wall 160 of axle carrier assembly 102 via a fitting 162 piercingly disposed in wall 160, as shown in FIG. 1. If axle carrier assembly 102 is, e.g. filled with oil, fitting 162 may be above an oil level 164 of the oil.

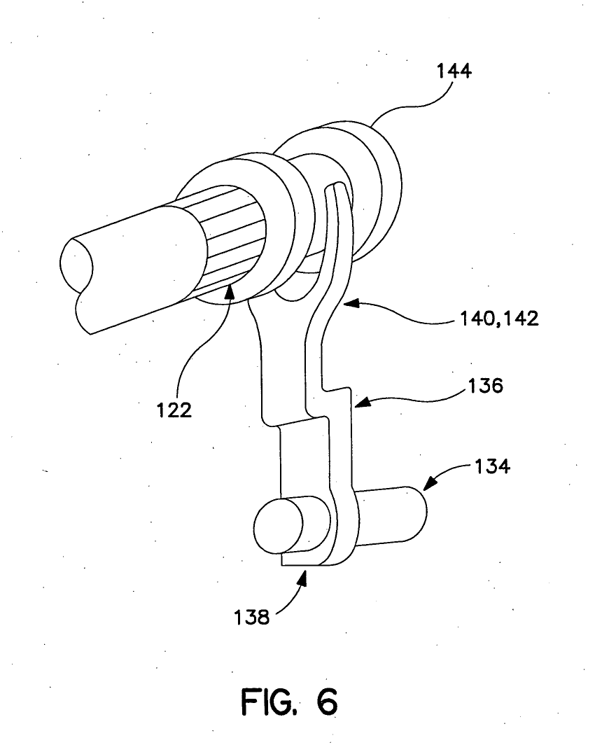

A lever 136 may be, e.g. fixedly disposed on rod 134, and have a first end 138 fixedly connected to rod 134, and a second end 140. Second end 140 may, e.g. be in the form of a fork 142 surrounding a collar 144 around second clutch element 122, in the manner of a throw-out bearing, as shown in FIG. 6. Lever 136 may move second clutch element 122 back and forth between first disengaged position 126 and second engaged position 128 when pressure is applied to piston 132.

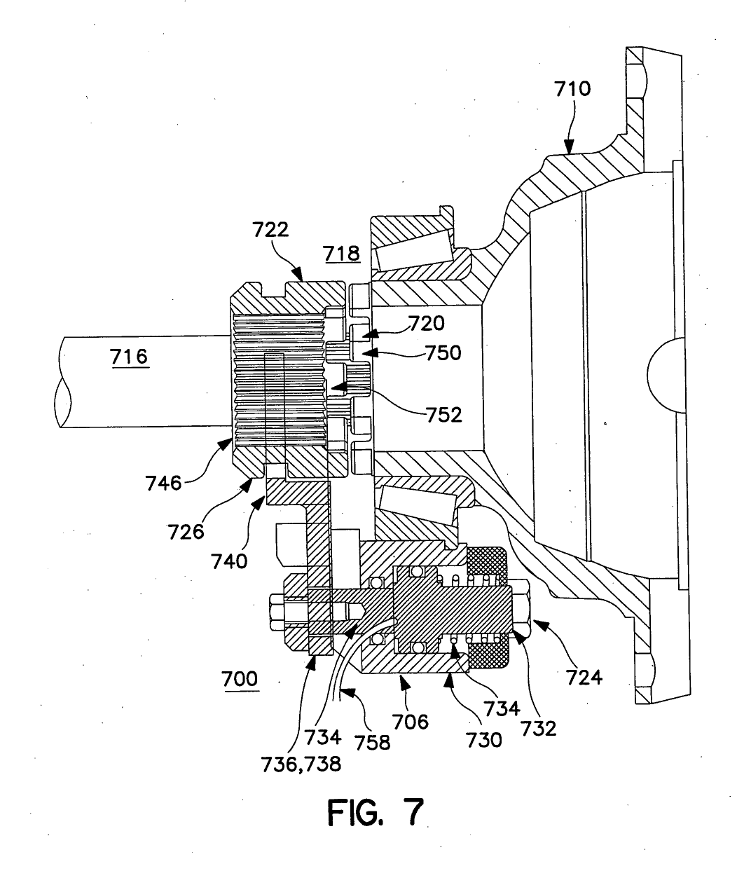

In a second embodiment, shown in FIG. 7, actuator 724 may be, e.g. a hydraulic actuator. In this embodiment, the mechanism of actuator 724 will be substantially similar to the first embodiment, with the exception that the fluid may be a hydraulic fluid. Lever 736 may thus move second clutch element 722 back and forth between first disengaged position 726 and second engaged position when pressure is applied to piston 732, in the same manner as the first embodiment.

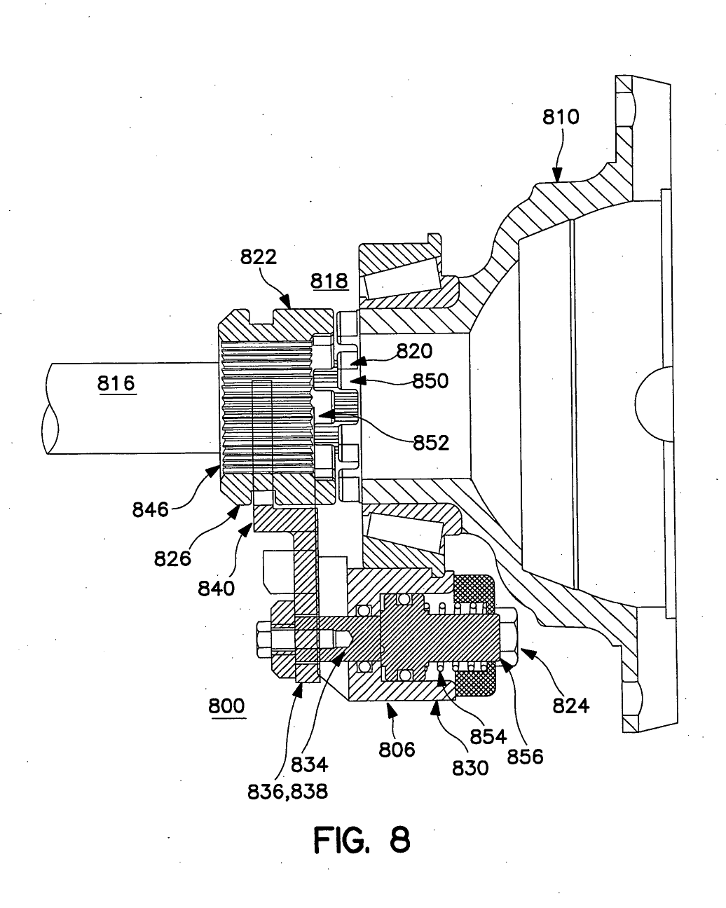

In a third embodiment, shown in FIG. 8, actuator 824 may be, e.g. an electronic actuator. In this embodiment, actuator 824 may include a coil 854 may be e.g. fixedly disposed within bearing cap 806, with a plunger 856 slidingly disposed within coil 854. Plunger 856 may be, e.g. a magnet, such as an electromagnet or a permanent magnet. Plunger 856 has a rod 834 to transfer pressure developed within coil 854 by an electromagnetic field acting on plunger 856 to an external entity, such as a lever 836. Lever 836 may thus move second clutch element 822 back and forth between first disengaged position 826 and second engaged position when an electromagnetic field is applied to coil 854, in the same manner as the first and second embodiments.

While the invention has been described in detail above, the invention is not intended to be limited to the specific embodiments as described. It is evident that those skilled in the art may now make numerous uses and modifications of and departures from the specific embodiments described herein without departing from the inventive concepts.

What is claimed is:

1. A wheel differential, comprising:
a differential housing;
a differential cage rotatably supported on said differential housing by a set of bearings;
a clutch assembly having a first member fixed to said differential cage and a second member configured to receive an axle half shaft extending from said differential cage for rotation with said axle half shaft; and,
a shift chamber disposed radially outwardly of an outer race member of said set of bearings;
a piston disposed within said shift chamber;
a pushrod coupled to said piston; and,
a shift arm coupled to said pushrod and configured to engage said second member of said clutch assembly.

2. The differential of claim 1, further comprising a spring that biases said piston in a first direction.

3. The differential of claim 2 wherein said spring comprises a wave spring.

4. The differential of claim 2 wherein a fluid force selectively urges said piston in a second direction, opposite said first direction.

5. The differential of claim 1 wherein said piston is urged in a first direction by a first fluid force and said piston is urged in a second direction, opposite said first direction, by a second fluid force.

6. The differential of claim 1 wherein said pushrod includes a flat and said shift chamber includes a support plate having an aperture with a corresponding flat, said aperture configured to receive said pushrod.

7. A wheel differential, comprising:
a differential housing;
a differential cage rotatably supported on said differential housing by a set of bearings;
a bearing cap coupled to said differential housing and disposed about at least a portion of said set of bearings;
a clutch assembly having a first member fixed to said differential cage and a second member configured to receive an axle half shaft extending from said differential cage for rotation with said axle half shaft; and,
a differential lock assembly including:
a shift chamber formed in said bearing cap;
a piston disposed within said piston; and,
a shift arm coupled to said pushrod and configured to engage said second member of said clutch assembly.

8. The differential of claim 7, further comprising a spring that biases said piston in a first direction.

9. The differential of claim 8 wherein said spring comprises a wave spring.

10. The differential of claim 8 wherein a fluid force selectively urges said piston in a second direction, opposite said first direction.

11. The differential of claim 7 wherein said piston is urged in a first direction by a first fluid force and said piston is urged in a second direction, opposite said first direction, by a second fluid force.

12. The differential of claim 7 wherein said pushrod includes a flat and said shift chamber includes a support plate having an aperture with a corresponding flat, said aperture configured to receive said pushrod.

13. The differential of claim 7 wherein said bearing cap defines an arcuate recess and shift chamber is arcuately centered relative to said recess.

14. A wheel differential, comprising;
a differential housing;
a differential cage rotatably supported on said differential housing by a set of bearings;
a ring gear coupled to said differential cage for rotation therewith;
a drive pinion in mesh with said ring gear and having an axis of rotation;
a clutch assembly having a first member fixed to said differential cage and a second member configured to receive an axle half shaft extending from said differential cage for rotation with said axle half shaft; and,
a differential lock assembly including:
a shift chamber disposed radially outwardly of an outer race member of said set of bearings;
a piston disposed within said shift chamber;
a pushrod coupled to said pushrod; and,
a shift arm coupled to said pushrod and configured to engage said second member of said clutch assembly;
wherein said differential lock assembly and said ring gear are located on the same side of said axis of rotation of said drive pinion.

15. The differential of claim 14, further comprising a spring that biases said piston in a first direction.

16. The differential of claim 15 wherein said spring comprises a wave spring.

17. The differential of claim 15 wherein a fluid force selectively urges said piston in a second direction, opposite said first direction.

18. The differential of claim 15 wherein said piston is urged in a first direction by a first fluid force and said piston is urged in a second direction, opposite said first direction, by a second fluid force.

19. The differential of claim 14 wherein said pushrod includes a flat and said shift chamber includes a support plate having an aperture with a corresponding flat, said aperture configured to receive said pushrod.

20. The differential of claim 14, further comprising a bearing cap coupled to said differential housing and disposed about at least a portion of said set of bearings, said shift chamber formed in said bearing cap.
